(19) United States
(12) Patent Application Publication
(10) Pub. No.: US 2021/0067476 A1
(43) Pub. Date: Mar. 4, 2021

(54) INTELLIGENT CHAT OBJECT SENDING ANIMATIONS

(71) Applicant: MICROSOFT TECHNOLOGY LICENSING, LLC, Redmond, WA (US)

(72) Inventors: Casey James Baker, Bellingham, WA (US); Jeremy Scott Frye, Mountlake Terrace, WA (US); Chris Lester, Everett, WA (US)

(73) Assignee: MICROSOFT TECHNOLOGY LICENSING, LLC, Redmond, WA (US)

(21) Appl. No.: 16/554,182

(22) Filed: Aug. 28, 2019

(51) Int. Cl. H04L 12/58; G06T 13/80; G06F 3/0485; G06F 3/0482

(52) U.S. Cl. CPC H04L 51/10; H04L 51/04; G06F 3/0482; G06F 3/0485; G06T 13/80

(57) ABSTRACT

Techniques for rendering animations on a display of a data processing system herein can be used with a messaging application to provide animations associated with one or more messages of a messaging session. These techniques include receiving a signal reflecting a user input to invoke an animation associated with a message displayed on a user interface of a display of a computing device, determining via a processor an animation point at a preset location specified relative to dimensions of the user interface or the display and not based on a location of the message, establishing via the processor an animation path that includes the animation point and a target display location relative to the location of the message, such that at least a portion of the animation is rendered from the animation point to the target display location relative to the message, and rendering the animation on the user interface according to the animation path.

### BACKGROUND

Messaging applications have become a popular means of communication that can provide real-time or near real-time exchange of messages between participants of a messaging session. Messaging applications may be standalone applications, such as a text messaging application for a mobile device that is configured to exchange Short Message Service (“SMS”) or Multimedia Message Service (“MMS”) from a mobile phone or other mobile device. Messaging applications may also be in-application services as one component of an application or suite of applications. In-application messages services may be used in social media platforms, collaborative work environment software, and numerous other types of application to facilitate communications between groups of users. Text alone has a limited ability to convey or express nuanced feelings or moods. Thus, there are significant areas for new and approved mechanisms for providing more engaging and interactive user experiences in messaging applications.

### SUMMARY

A computing device according to one aspect of this disclosure includes a processor and a computer-readable medium storing executable instructions for causing the processor to perform operations that include: receiving a signal reflecting a user input to invoke an animation associated with a message displayed on a user interface on a display of a computing device, determining an animation point at a preset location specified relative to dimensions of the user interface or the display and not based on a location of the message, establishing an animation path that includes the animation point and a target display location relative to a location of the message, such that at least a portion of the animation is rendered from the animation point to the target display location relative to the message, and rendering the animation on the user interface according to the established animation path.

A method, executed by a data processing system for rendering animations on a display, according to a second aspect of this disclosure includes receiving a signal reflecting a user input to invoke an animation associated with a message displayed on a user interface on a display of a computing device; determining via a processor an animation point at a preset location specified relative to dimensions of the user interface or the display and not based on a location of the message; establishing via the processor an animation path that includes the animation point and a target display location relative to the location of the message, such that at least a portion of the animation is rendered from the animation point to the target display location relative to the message; and rendering the animation on the user interface according to the animation path.

A memory device according to a third aspect of this disclosure stores instructions that, when executed on a processor of a computing device, cause the computing device to render an animation on a user interface, by: receiving a signal reflecting a user input to invoke an animation associated with a message displayed on a user interface on a display of the computing device; determining an animation point at a preset location specified relative to dimensions of the user interface or the display and not based on a location of the message; establishing an animation path that includes the animation point and a target display location relative to the location of the message, such that at least a portion of the animation is rendered from the animation point to the target display location relative to the message; and rendering the animation on the user interface according to the animation path.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 presents an example operating environment in which techniques for displaying animations in a messaging system may be used;

FIGS. 2A-2U present examples of user interfaces that illustrate techniques for displaying animations in a messaging session;

FIG. 3 presents a flowchart of an example process for rendering an animation in a messaging session;

FIG. 4 presents a flowchart of another example process for rendering an animation in a messaging session;

FIG. 5 presents a flowchart of another example process for rendering an animation in a messaging session;

FIG. 6 presents a flowchart of another example process for rendering an animation in a messaging session;

FIG. 7 is a block diagram illustrating an example software architecture, various portions of which may be used in conjunction with various hardware architectures herein described, which may implement any of the features herein described; and

FIG. 8 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings. In the following material, indications of direction, such as “top” or “left,” are merely to provide a frame of reference during the following discussion, and are not intended to indicate a required, desired, or intended orientation of the described articles.

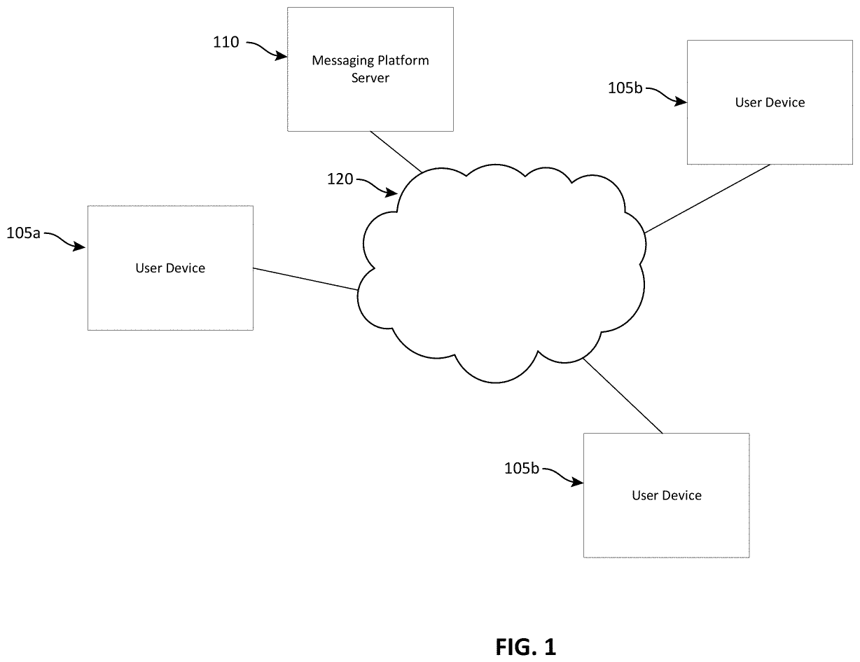

FIG. 1 illustrates an example operating environment in which includes user devices 105a, 105b, and 105c, and a messaging platform server 110. The user devices 105a-105c may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. The messaging platform server 110 may comprise one or more computing devices that are configured to support a messaging session between the user devices. The messaging platform server 110 may support a collaborative software platform that facilitates communications between groups of users or may support a social media network that provides messaging between groups of users. The messaging platform server 110 may be part of a mobile wireless network provided by a wireless network provider, and the messaging platform server 110 may facilitate text and/or multimedia messaging among network subscribers and/or between network subscribers and subscribers to another networks.

The user devices 105a-105c each comprise a computing device that includes at least one display that can display a messaging user interface, a wired and/or wireless interface for exchanging messaging data with other user devices, and user interface means for controlling the messaging interface. The user interface means can include a keyboard, touch screen, a microphone, a camera, and/or other user interface components for receiving message content input from a user and for controlling the sending of message content to other users. The messaging interface may be implemented as a messaging application executable by a processor of the user device. The messaging interface may be a component of another application, such as a social media application, a collaborative software platform, or other application where users may exchange messages. Messages may typically include text content, but may also include non-textual content, such as multimedia content, files, data, and/or other information that may be shared by users of such software.

The wired and/or wireless interface for exchanging messaging data may comprise a wired or wireless network interface to facilitate establishing a network connection to the network 110 to communicate with other network-enabled devices. The network 110 may comprise one or more public or private networks and may be the collection of networks referred to as the Internet. The user devices 105a-105c may be configured to communicate using various communication protocols over wired and/or wireless network connections, such as but not limited to Wireless Local Access Network (WLAN), Wireless Wide Area Network (WWAN), or other types of wireless communications protocols. The user devices 105a-105c may be configured to communicate directly with other user devices, such as the user devices 105a-105c, or other user devices suitably equipped for wireless communications without any intervening network by using BLUETOOTH and/or other wireless communication protocols.

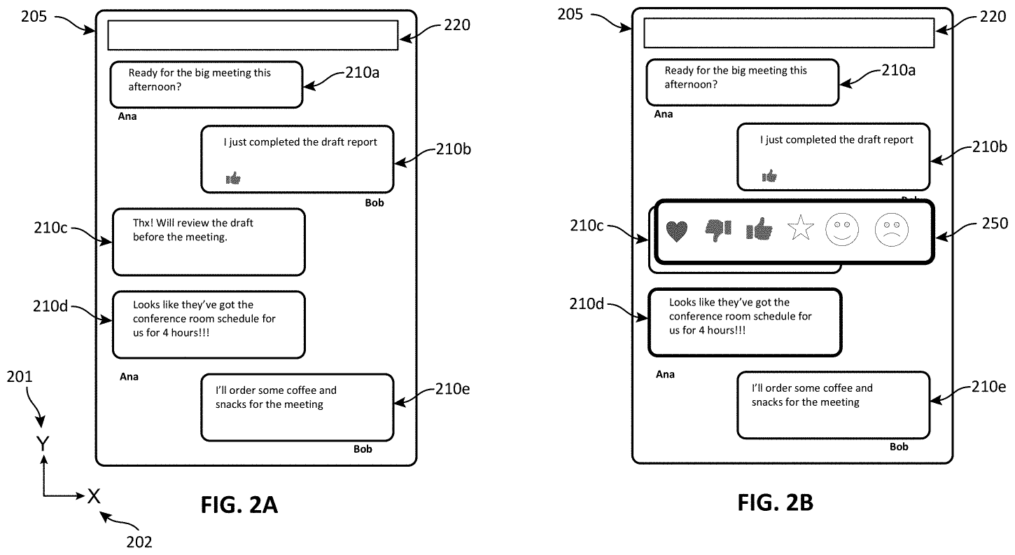

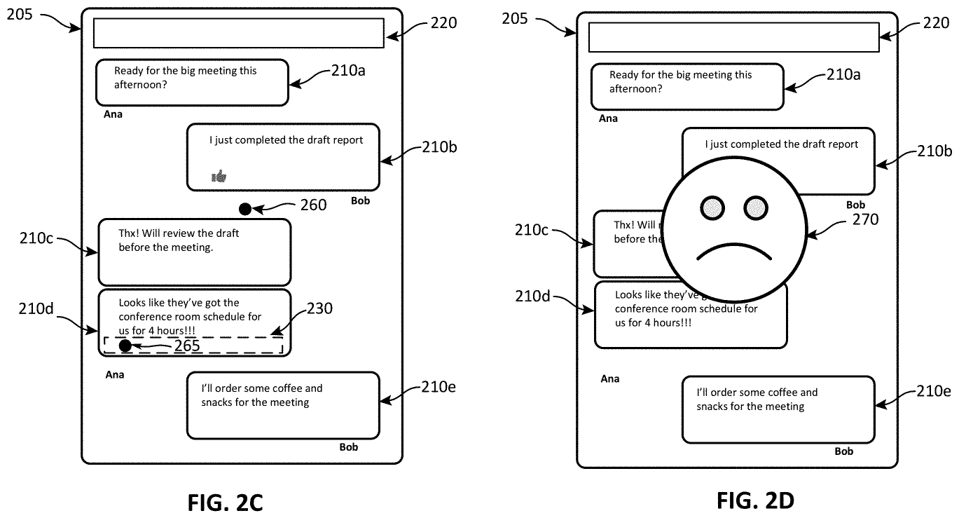

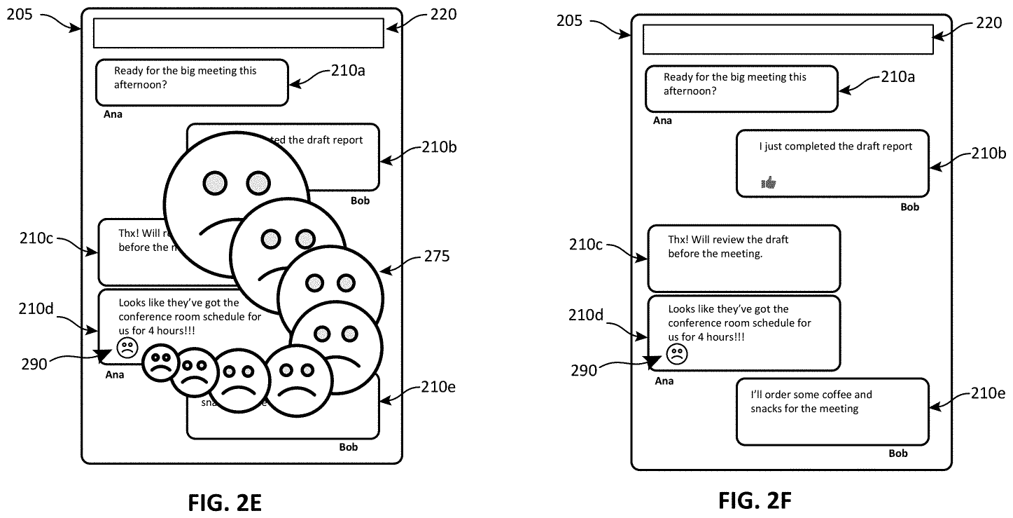

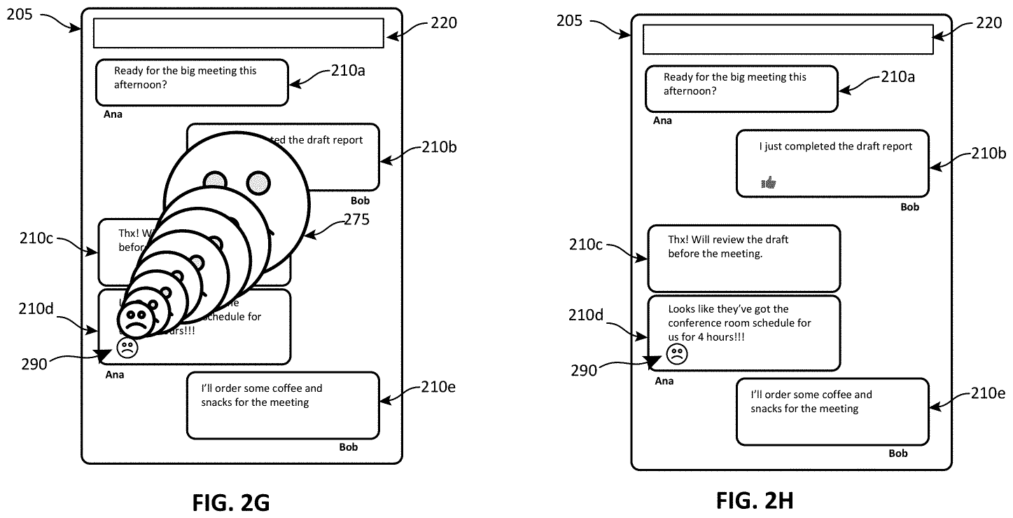

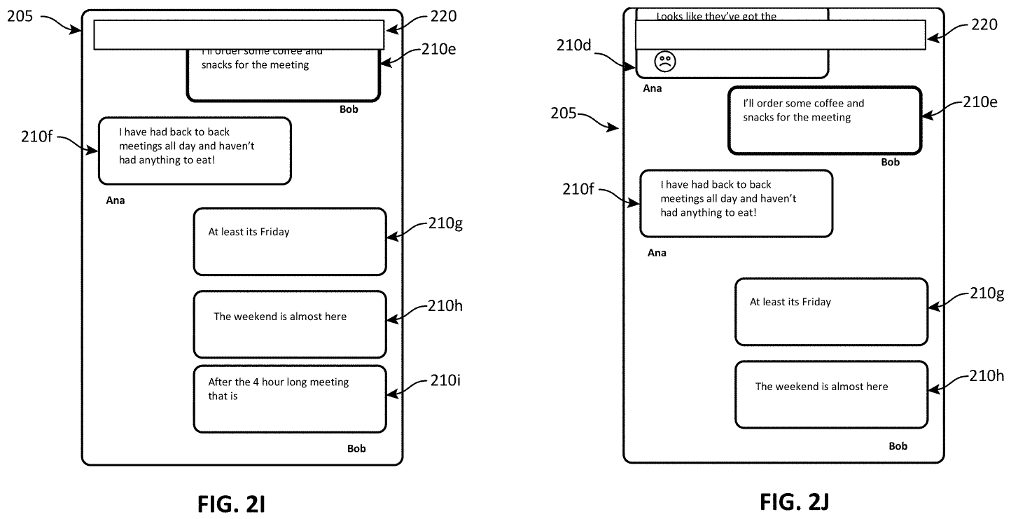

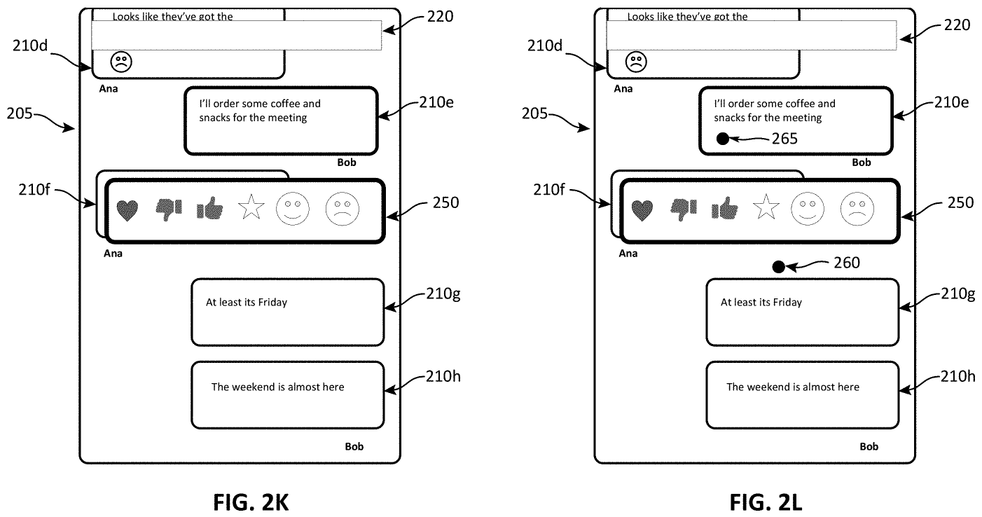

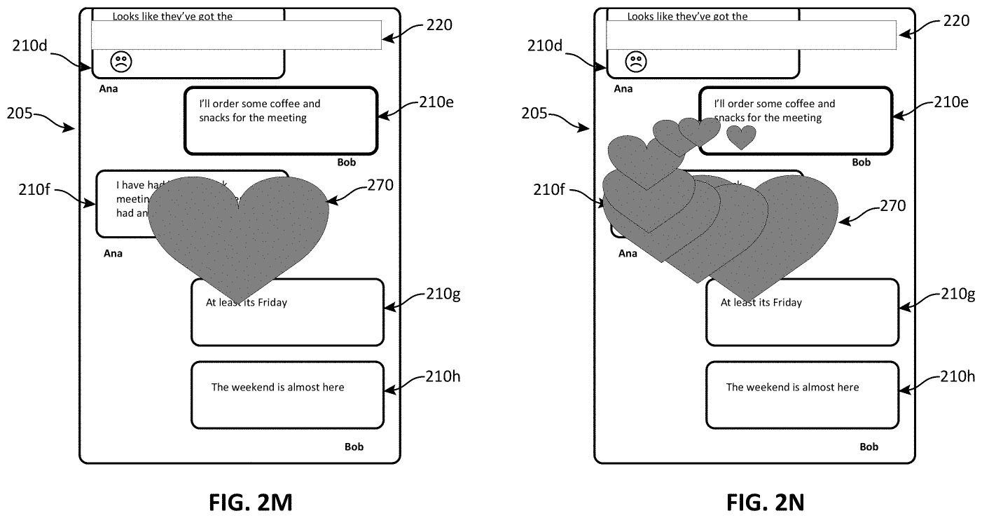

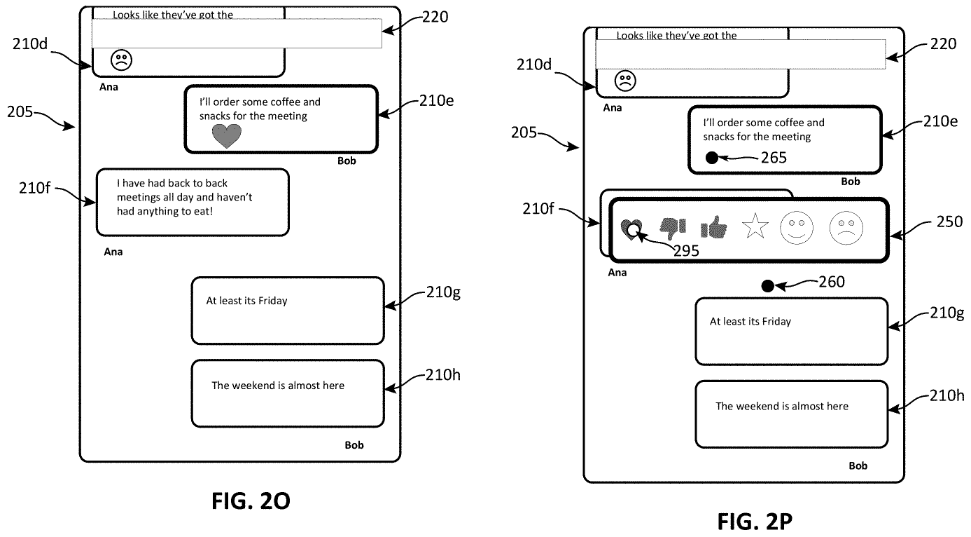

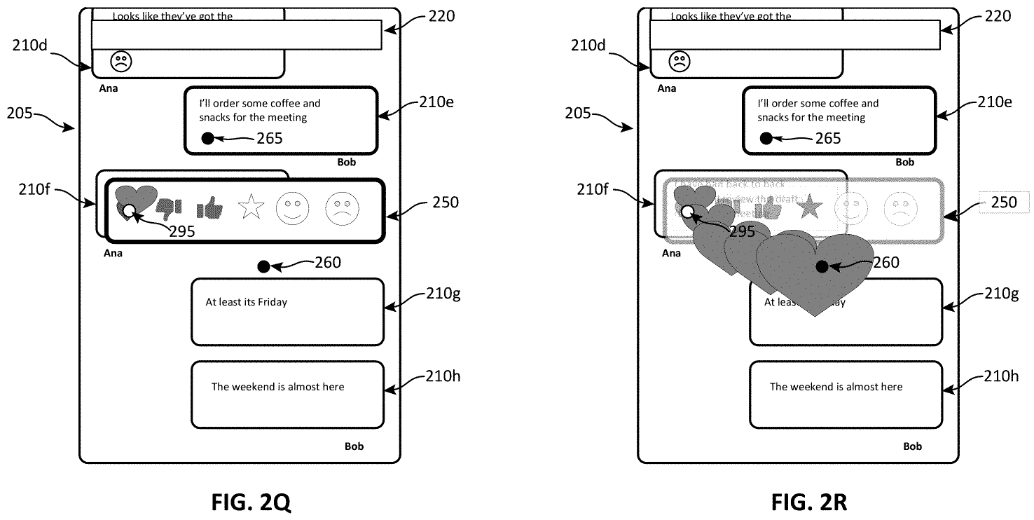

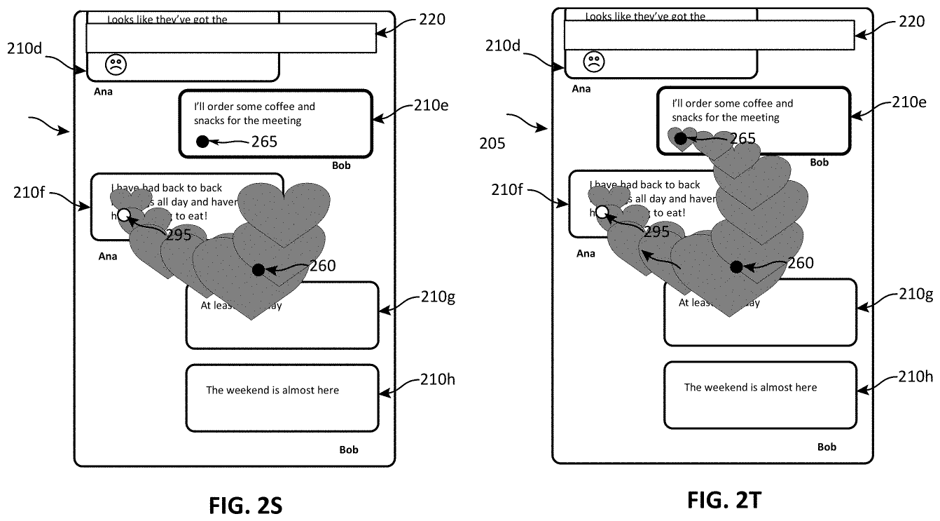

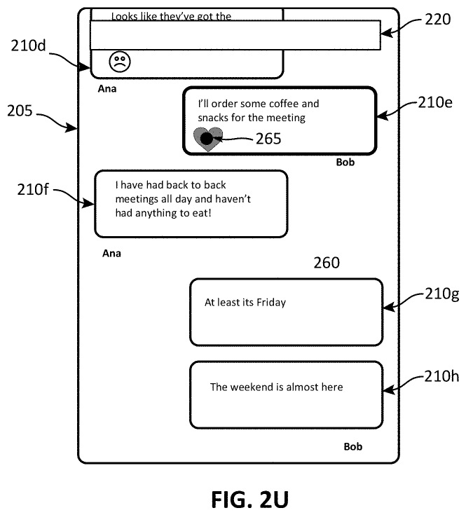

FIGS. 2A-2U illustrate example user interfaces that may be implemented by a user device, such as the user devices 105a-105c. FIGS. 2A-2U illustrate examples of various animation techniques that may be integrated into a messaging application. The messaging interface may be a standalone messaging application dedicated to users exchanging messages, or may be component of another application, such as a social media application, a collaborative communications software platform, or other application where users may exchange messages. The examples illustrated in FIGS. 2A-2U refer to the messaging application performing various tasks related to rendering animations within the messaging user interface. It is understood that the messaging application may have access to various functions of the operating system (OS), libraries, frameworks, and a presentation layer of software operating of the data processing system in order to render the user interface of the messaging application and perform the various operations discussed in these examples.

FIG. 2A-2U illustrate various examples of a user adding a “reaction” to a message of a messaging session illustrated in a messaging user interface 205. The term “reaction” as used herein refers to an icon or other graphical indication that a user may add to a message in a messaging session to express a sentiment about that message. The icons or other graphical indications may be referred to as “emoticons.” Emoticons provide a shorthand for a user to quickly express nuanced feelings or moods with a single icon or other graphical indication. The various techniques disclosed herein provide techniques for providing animated reactions in a messaging session, such as the example message session depicted in FIGS. 2A-2U. It is understood that these examples are included to illustrate the techniques disclosed herein and are not intended to limit the scope of the claims to the particular configurations illustrated in the examples of FIGS. 2A-2U.

FIGS. 2A-2F are a sequence of block diagrams of the messaging user interface 205 that illustrate an example process in which an animated reaction is generated in response to receiving a signal reflecting a user input to invoke an animation associated with the message 210d displayed in the message user interface 205. The message may be selected through various means. The user interface 205 may be displayed on a touchscreen of a user device 105 that is configured to detect contact with the screen. For example, the user may click on the message in the touch screen to select the message. In other configurations, the user may click and hold the message for a predetermined period to invoke an animation. In other configurations, the user may use a mouse, a touchpad, or other pointing device that can be used to interact with content displayed on the user interface of the computing device 105, such as the message user interface 205. In other configurations, the user device 105 may provide a voice interface that enables the user to issue voice commands to interact with the messaging user interface 205. These examples are merely intended to illustrate the concepts disclosed herein and do not limit the user input to these specific examples.

FIG. 2A illustrates an example messaging user interface 205 of a messaging application in which two users “Ana” and “Bob” are exchanging messages 210a-210e. The messaging user interface 205 includes messages from two users in order to more clearly illustrate the concepts that are disclosed herein, but the messaging user interface 205 is not limited to two users and may support messaging sessions between multiple users. For reference purposes, a first axis 201 substantially parallel to a horizontal axis is depicted, along with a second axis 202 that is substantially orthogonal to the first axis. The first axis 201 is also referred to herein as the “height” or the “y-axis” of the user interface 205, and the second axis 202 is also referred to herein as the “width” or the “x-axis” of the user interface 205. The first axis 201 and the second axis 202 are merely included for reference purposes and are not typically rendered as part of the messaging user interface 205.

Some implementations of the messaging application may be implemented for the Android operating system, and the messaging user interface 205 may be implemented using ListView. ListView displays a vertically scrollable collection of views. A view is a basic building block for the creation of user interface components in the Android operating system. Each view occupies a rectangular area of the display and is responsible for drawing and event handling. The ListView can be used to implement the messaging user interface 205 by rendering a view of a list of message objects. Each message object can provide a view associated with that message. For example, a message object can be configured to provide a view that renders a “message bubble” around the text of the message as illustrated in FIG. 2A. The message object may also provide event handling for events, such as the user selection of a message via touchscreen, a pointer such as a touchpad or mouse, or via voice commands.

The messaging user interface 205 may include a message entry field 220, in which a user may enter a new message to add to the messaging session. For example, in Android implementations, the message entry field 220 may be implemented as an EditText user interface element, and a new message object is added to the ListView in response to the message being entered by the user. The ListView can be refreshed and the newly added message can provide a view that includes the message entered by the user rendered in a chat bubble, such as those illustrated in FIGS. 2A-2U.

The messaging user interface may implement one or more event listeners configured to listen for events associated with a message and to perform one or more actions in response to detecting such an event. The types of listeners utilized may depend upon the particular implementation used. The message objects may include a listener that responds to touch event when the display of the user device 105 is a touchscreen. The message objects may include a listener that responds to “on-click” events where the user device 105 includes a pointer device, such as a mouse or trackpad, that the user may use to interact with the messaging user interface 205. The messaging user interface 205 and/or the message objects may also include a listener that responds to voice-command events where the messaging user interface 205 is configured to provide a voice-based command interface. Other types of listeners may be associated with the message objects for processing other types of events.

In the example illustrated in FIG. 2B, a reactions toolbar 250 is rendered on the messaging user interface 205 in response to the signal reflecting the user input to invoke an animated reaction. The reactions toolbar 250 may be implemented as a context menu that is rendered over the message user interface 205 in response to the user input. The reactions toolbar 250 may be rendered in response to detecting a touch, click, or other type of event selecting a message bubble displayed in the messaging user interface 205. In the examples illustrated in FIGS. 2A-2U, the reactions toolbar 250 includes a list of emoticons representing reactions that a user may select to add a reaction to a selected message and invoke the reaction animation associated with the selected emoticon. The reactions toolbar 250 includes a series of emoticons arranged horizontally, and the user can scroll over to or click on an emoticon to select that emoticon. The arrangement of the emoticons and the emoticons included in the reactions toolbar 250 are intended to illustrate the techniques disclosed herein and are not intended to limit these techniques to this particular configuration or selection of emoticons.

When a user selects an emoticon from the reactions toolbar 250, an animation associated with the selected emoticon may be rendered. Each emoticon included in the reactions toolbar 250 is associated with an emoticon identifier value. The emoticon identifier value may be an integer value associated with each emoticon and may be used by the messaging user interface 205 to identify an animation associated with the selected emoticon. The emoticon identifier may be an index value representing the position of the respective emoticon in the list of emoticons displayed by the reactions toolbar 250 or may be another value associated with the emoticon that can be used to identify which emoticon the user selected. Each message included in the list of messages is also associated with a message identifier. The message identifier may be an index value representing the position of that message in the list of messages associated with the messaging session being displayed by the messaging user interface 205 or may be another value assigned to each message such that each message of the messaging session can be uniquely identified.

The emoticon identifier and the message identifier can be passed to a render animation object that is configured to render a reaction animation over the contents of the messaging user interface 205. The render animation object can use the emoticon identifier value to determine which reaction animation(s) should be rendered in response to the user selecting the indication that a user has selected a particular reaction emoticon. The messaging application may maintain a mapping which animation(s) are associated with each reaction emoticon. More than one animation may be associated with a particular reaction emoticon, and timing information can also be associated with the reaction emoticon that indicates the order in which the animations should be rendered. The animations may be rendered sequentially, or one or more of the animations may be rendered concurrently. Rendering parameters may also be associated with each animation. The rendering parameters may include transparency or opacity control information, color information, size information for the animation. The rendering parameters may be expressed as a function of time or be associated with a frame identifier of frames of the animation and can be changed to alter the color(s), size, opacity, and/or other parameters as the animation is rendered.

FIG. 2C illustrates an example of the messaging user interface in which a user has selected message 210d, and then selects the frowny face emoticon from the list of emoticons in the reactions toolbar 250. The reactions toolbar 250 disappears after the emoticon is selected in this example implementation, but a fade effect could be implemented to cause toolbar to fade away gradually. The render animation object is passed the message identifier associated with message (e.g. message identifier=“3”) and emoticon identifier (e.g. emoticon identifier=“5”). These values represent an index of the message in the list of messages associated with the messaging session and the index of the location of the selected emoticon, respectively.

An animation path for the reaction animation may then be established. The animation path is a path on the messaging interface 205 along which the reaction animation is to be rendered. An initial display location, an animation point (also referred to herein as an intermediate point), and a target display location may be determined. The initial display location represents a starting location on the messaging user interface 205 at which the animation is initially rendered. The animation point represents an intermediate point along the animation path that is a preset location specified relative to dimensions of the messaging user interface 205 or the display of the user device 105 on which the messaging user interface 205 is displayed. The target display location represents an end point for the animation path. The target display location may be defined relative to a location of the message on the message user interface 205 or a representation of such a message, such as a chat bubble or other user interface component that may be rendered for the message. The animation path is established such that at least a portion of the animation is rendered from the animation point to the target display location.

The animation path may be rendered from the initial display location to the target display location as a straight line, curve, or set of linear or curvilinear segments in which the animation point is an intermediate point on the animation path that falls between the initial display location and the target display location. In some implementations, the initial display location and the animation point are the same point, and the initial display location is a preset location specified relative to dimensions of the messaging user interface 205 or the display of the user device 105 on which the messaging user interface 205 is displayed. Furthermore, it is possible that a first animation or set of animations may be rendered up until the animation path reaches the animation point, and a second animations or set of animations may be rendered along the animation path between the animation point and the target display location.

FIG. 2C illustrates an example where the initial display location is the same point as the animation point. The animation point 260 is a preset location specified relative to dimensions of the messaging user interface 205 or the display of the user device 105 on which the messaging user interface 205 is displayed, and may be determined based in part on the dimensions of the reaction animation to be rendered. The target display location 265 in this example falls within the message bubble associated with message 210d. The animation path along which the reaction animation will be rendered will start at the animation point 260 and end at the target display location 265. The animation path may be a straight line that connects these points (e.g. FIG. 2G) or may be a curved path (e.g. FIG. 2E). The shape of the path may be determined at least in part by the reaction animation that is to be rendered. While the animation point 260 and the target display location 265 are shown on the example messaging user interface 205 illustrated in FIG. 2C, these points typically would not be visibly rendered on the messaging user interface. Instead, these points serve as references points for establishing an animation path.

The animation point 260 may be determined based on the dimensions of the messaging user interface 260. The height (H_{UI}) along the y-axis and width (W_{UI}) along the x-axis of a viewable area of the messaging user interface 205 may be determined. This viewable area may match the dimensions of the display upon which the messaging user interface 205 is rendered or may be smaller than the dimensions of the display if the messaging user interface 205 does not occupy the entire viewable area of the display. The height and width may be determined in pixels, millimeters, inches, or another unit of measurement. In some implementations, the animation point 260 is determined as a center point of the messaging user interface 260 in which the x and y coordinates of the animation point 260 are ½H and ½W, respectively. In other implementations, the animation point 260 may be offset from the center point of the messaging user interface 260. The animation point 260 may be located at the top left of the messaging user interface 260 (x=0, and y=H_{UI}), the top center of the messaging user interface 260 (x=W_{UI}/2, y=H_{UI}), the top right of the messaging user interface 205 (x=W_{UI}, Y=H_{UI}), the bottom left of the messaging user interface 205 (x=0, y=0), the bottom center (x=W_{UI}/2, y=0), or the bottom right of the messaging user interface 205 (x=W_{UI}, y=0). These examples are meant to illustrate that the animation point 260 may be determined based on the dimensions of the messaging user interface 260 or the display of the user device 105.

The animation point examples discussed above may be offset by dimensions of the animation so that the animation does exceed the boundaries of the viewable area of the messaging user interface 205. The width of the animation may be expressed as W_{A} and the height of the animation may be expressed as H_{A}. The animation point 260 may be located at the top left of the messaging user interface 260 (x=0+W_{A}, and y=H_{UI}−H_{A}), the top center of the messaging user interface 260 (x=W_{UI}/2, y=H_{UI}−H_{A}), the top right of the messaging user interface 205 (x=W_{UI}−W_{A}, Y=H_{UI}−H_{A}), the bottom left of the messaging user interface 205 (x=0+W_{A}, y=0+H_{A}), the bottom center (x=W_{UI}/2, y=0+H_{A}), or the bottom right of the messaging user interface 205 (x=W_{UI}, y=0+H_{A}). These examples are meant to illustrate that the animation point 260 may be determined based on the dimensions of the messaging user interface 260 or the display of the user device 105 and the dimensions of the animation to be rendered and do not limit the scope of the invention or the claims to these specific examples.

The target display location 265 in this example falls within the message bubble associated with message 210d. The coordinates of the message bubble associated with the message 210d can be determined. The coordinates of the message bubble can be determined based on the location of the message in the list of messages. The index of the message can be used to determine where the message bubble associated with message 210d appears relative to the visible portion of the messaging user interface 205. The index of the message can be used to determine the coordinates of the messages bubble associated with the message. The coordinates may be associated with a predetermined location on the message bubble (e.g. the bottom left corner, upper right corner, center point) of the message bubble associated with the message. In Android based implementations, the dimensions of the message bubble rendered for a message and the coordinates of one or more reference points of the message bubble (e.g. top left corner, bottom right corner) may be obtained from the view associated with that message (which may be in turn be contained by a ListView as discussed above).

The target display location 265 can be determined based on the location of a reaction icon placement area 230 denoted by the dashed line in the message bubble associated with the message 210d. The reaction icon placement area 230 is rendered at a predetermined location within the message bubble, such as but not limited to below the message text as illustrated in the example of FIG. 2C. There may be multiple reactions associated with a message. The message object associated with a message can include a data structure for storing the contents of the message and a list of identifiers of reactions associated with the message. When a reaction is added to a message, information identifying the reaction may be added to the list of identifiers associated with the message object, and the view associated with that message object can be updated to render an emoticon or other graphical representation of the reaction that was added to the message. The information identifying a reaction may also include a count of how many times that a reaction has been added to the message. The information identifying the reaction may also include a location in memory of the graphical content representing the reaction to be rendered in the view of the message rendered on the messaging user interface 205. The location of the target display location 265 may then be determined based on an offset within the reaction icon placement area 230, depending upon how many reactions (if any) have been added to the message.

FIG. 2D illustrates an example of the messaging user interface 205 in which the rendering of the animation sequence initiated in FIG. 2C continues. In this example, the initial display location of the animation is the same as the animation point 260, which was determined above based on the dimensions of the messaging user interface 205. In this particular example, the animation point 260 is located in the center of the display area of the messaging user interface 205, and an initial frame of the animation is 270 is centered over the animation point 260. The animation in this example is a frowny face animation that corresponds to the frowny face emoticon that was selected in FIG. 2B.

FIG. 2E illustrates an example of the messaging user interface 205 in which the animation sequence 275 initiated in FIG. 2D continues to be rendered along the animation path that a was established between the animation point 260 and the end point 265 that were determined in response to the user selecting the animation in FIG. 2B. In this example, the animation is drawn as an opaque overlay over the contents of the messaging user interface 205. However, the animation may be rendered as a semi-transparent overlay, and the opacity, color, size, and/or other rendering parameters of the animation may change over the course of the animation being rendered along the animation path. In the example illustrated in FIG. 2E, the animation path has been established as a curve along which the frames of animation have been rendered. In the example illustrates in FIG. 2E, the animation sequence includes a plurality of representations of the emoticon that have been rendered along the curved animation path. In this example, each subsequent frame of the animation has been drawn over the preceding frame of animation and the preceding frame of animation remains visible. In other implementations, the preceding frames of the animation may not persist, and may instead progressively fade out as the animation sequence progresses or the preceding frame may disappear as the current frame of animation is rendered. The animation sequence follows the animation path that was established until a representation of the emoticon 290 is added to the message bubble of the message 210d at the target display location 265. The animation sequence disappears or may fade out after the sequence is completed. However, the representation of the reaction emoticon 290 remains in the message bubble of the message 210d as illustrated in FIG. 2F.

FIG. 2G illustrates an alternative example in which the animation path established for the reaction animation is a straight path between the animation point 260 and the target display location 265. In this example, the animation point 260 is determined in a similar manner as the process discussed with respect to FIG. 2C. The animation sequence once again follows the animation path that was established until a representation of the emoticon 290 is added to the message bubble of the message 210d at the target display location 265. The animation sequence disappears or may fade out after the sequence is completed. However, the representation of the reaction emoticon 290 remains in the message bubble of the message 210d as illustrated in FIG. 2H.

FIGS. 2I-2O are a sequence of block diagrams of the messaging user interface 205 that illustrate another example in which an animated reaction is generated in response to receiving a signal reflecting a user input to invoke an animation associated with the message in the message user interface 205. In this example, the contents of the messaging user interface 205 have exceeded the display area available to the messaging user interface 205. Accordingly, some of the message content has scrolled off screen as illustrated in FIG. 2I.

In FIG. 2J, a determination that the message 210e, which was selected in FIG. 2I, is partially outside of the viewable area of the messaging user interface 205. A determination that the message 210e is not fully visible in the messaging user interface 205 can be made in response to the user input selecting message 210e. The messaging application may determine whether the message is currently visible based on the position of the message in the list of messages displayed by the messaging user interface 205.

The messaging application may obtain the coordinates of the message from the message object associated with that message. The message obtain may provide coordinates of the message within the messaging user interface 205. These coordinates can be used by the messaging application to determine whether the message falls within a visible portion of the contents of the messaging user interface 205. As discussed in the preceding examples, the messaging user interface 205 may be implemented as a ListView and each message object may provide its respective coordinates to the message user interface 205.

In FIG. 2K, the contents of the screen have been scrolled such that the message 210e is fully visible as in FIG. 2J, and the reactions toolbar 250 is rendered over the messaging user interface 205 as discussed with respect to FIG. 2B in the preceding example. In the example illustrated in FIGS. 2I-2O, the reactions toolbar 250 is rendered over the messaging user interface 250 after the contents of the messaging user interface 205 have been scrolled such that the message 210e selected by the user is visible prior to rendering the reactions toolbar 250. However, in other implementations, the reactions toolbar 250 may be rendered on the messaging user interface 205 proximate to the location of the selected message, and the determination whether the selected message is fully visible may be performed after the reactions toolbar 250 is rendered. In this second scenario, when the contents of the messaging user interface 205 are scrolled to make the message 210e fully visible, the reactions toolbar 250 may also be scrolled with the other contents of the messaging user interface 205. Alternatively, the messaging application may redetermine the position of the reactions toolbar 250 after the contents of the messaging user interface 205 are scrolled such that the selected message is visible.

The messaging application can scroll the contents of the messaging user interface 205 such that the selected message becomes visible. The messaging application may scroll the contents of the user interface so that the selected message aligns with a predetermined location within the visible portion of the messaging user interface 205. The messaging user interface may determine a top visible message location at which a message at that location would be fully visible at a location proximate to the top of the messaging user interface 205. The messaging user interface may determine a center visible message location at which the message would be approximately centered within the messaging user interface 205. The messaging user interface may also determine a bottom visible message location at which the message would be located at a location proximate to the bottom of the messaging user interface 205. The messaging user interface 205 may select from one of these locations that is closest to a current location of the message that would minimize the movement of the contents of the messaging user interface 205.

As discussed in the preceding examples, the messages objects may each provide a view that is included in a ListView that provides a scrollable user interface that contains the messages, and the ListView object can provide methods for controlling the scrolling of the contents of the user interface to a particular message object included in the list.

FIG. 2L illustrates an example of the messaging user interface 205 in which the rendering of the animation sequence initiated in FIG. 2K continues. In the example illustrated in FIG. 2C, a user has selected message 210e, and then selects the heart emoticon from the list of emoticons from the list of emoticons in the reactions toolbar 250. The reactions toolbar 250 disappears after the emoticon is selected. The render animation object is passed the message identifier associated with message (e.g. message identifier=“4”) and emoticon identifier (e.g. emoticon identifier=“0”). These values represent an index of the message in the list of messages associated with the messaging session and the index of the location of the selected emoticon, respectively.

The animation point 260 of the animation path is established based on the dimensions of the messaging user interface 205 using the process discussed above with respect to FIG. 2C. In this example, the initial display location and the animation point 260 are the same point. In examples that follow, the initial display location and the animation point are separate points and the locations of each of these points will be determined separately. The target display location 265 for the animation path is established using the process discussed above with respect to FIG. 2C. In the example illustrated in FIG. 2C, the target display location falls within the message bubble associated with message 210e. As discussed above, although the animation point 260 and the target display location 265 are shown on the example messaging user interface 205 illustrated in FIG. 2L, these points typically would not be visibly rendered on the messaging user interface. Instead, these points serve as references points for establishing the animation path.

FIG. 2M illustrates an example of the messaging user interface 205 in which the rendering of the animation sequence initiated in FIG. 2L continues. In this example implementation, the initial display location of the animation is the same as the animation point 260, which was established above based on the dimensions of the messaging user interface 205. In this particular example, the animation point 260 is located in the center of the display area of the messaging user interface 205, and an initial frame of the animation is 270 is centered over the animation point 260. The animation in this example is a heart animation that corresponds to the heart emoticon that was selected in FIG. 2L.

FIG. 2N illustrates an example of the messaging user interface 205 in which the animation sequence initiated in FIG. 2D continues to be rendered along the animation path that a was established between the animation point 260 and the end point 265 that were determined in response to the user selecting the animation in FIG. 2M. In this example, the animation is drawn as an opaque overlay over the contents of the messaging user interface 205. However, the animation may be rendered as a semi-transparent overlay, and the opacity of the animation may change over the course of the animation being rendered along the animation path. In the example illustrated in FIG. 2N, the animation path has been established as a curve along which the frames of animation have been rendered, similar to that illustrated in FIG. 2E. In the example illustrated in FIG. 2N, the animation sequence includes a plurality of representations of the emoji that have been rendered along the curved animation path. In this example, each subsequent frame of the animation has been drawn over the preceding frame of animation and the preceding frame of animation remains visible. In other implementations, the preceding frames of the animation may not persist, and may instead progressively fade out as the animation sequence progresses or the preceding frame may disappear as the current frame of animation is rendered. The animation sequence follows the animation path that was established until a representation of the emoticon 290 is added to the message bubble of the message 210e at the target display location 265. The animation sequence disappears or may fade out after the sequence is completed. However, the representation of the reaction emoticon 290 remains in the message bubble of the message 210e as illustrated in FIG. 2O.

FIGS. 2P-2U are a sequence of block diagrams of the messaging user interface 205 that illustrate another example in which an animated reaction is generated in response to receiving a signal reflecting a user input to invoke an animation associated with the message in the message user interface 205. In this example, an initial display location 295, an animation point 260 (or intermediate point), and a target display location 265 are determined. The initial display location represents a starting location on the messaging user interface 205 at which the animation is initially rendered. The animation point represents an intermediate point along the animation path that is a preset location specified relative to dimensions of the messaging user interface 205 or the display of the user device 105 on which the messaging user interface 205 is displayed.

The location of the animation point 260 and the target display location 265 may be determined as discussed in the preceding examples, such as FIG. 2C. The initial display location may be determined based on a reference point relative to the location of the message selected by the user (e.g. message 210e), the location of the reactions toolbar 250 or a selected emoticon from the reaction toolbar 250, or relative to the dimensions of the messaging user interface 205 or the display of the user device 105 on which the messaging user interface 205 is displayed. While the initial display location 205, the animation point 260, and the target display location 265 are shown on the example messaging user interface 205 illustrated in FIG. 2R, these points typically would not be visibly rendered on the messaging user interface. Instead, these points serve as references points for establishing the animation path.

FIG. 2Q illustrates an example of the messaging user interface 205 in which the rendering of the animation sequence initiated in FIG. 2P continues. In this example implementation, the initial display location 295 of the animation is not the same location as the animation point 260, which was determined above based on the dimensions of the messaging user interface 205. In this example, the initial display location 295 is located proximate to location of the heart emoticon in the reactions toolbar 250, and an initial frame of the animation is 270 is centered over the initial display location 295. The animation in this example is a heart animation that corresponds to the heart emoticon that was selected in FIG. 2P. The initial display location 295 may be a predetermined point determined based on a location on the user interface where the user input initiated the reaction animation sequence, such as a location proximate to the location of the emoticon of the reactions toolbar 250 that the user selected. In other implementations, the initial display location may be a predetermined location on the user interface that may be determined based on dimensions of the user interface in manner similar to the animation point 260 discussed in the preceding examples.

FIG. 2R illustrates an example of the messaging user interface 205 in which the rendering of the animation sequence initiated in FIG. 2Q continues. The animation continues to be rendered along the animation path to reach the animation point 260. At least a portion of the animation will be displayed at the animation point 260. The reactions toolbar 250 in this example is configured to gradually fade away. The opacity of the reactions toolbar 250 may be decreased as successive frames of the reaction animation are rendered on the messaging user interface 205. Selecting the reaction from the reactions toolbar 250 can trigger the messaging application to cause the reactions user interface 250 to disappear as in the preceding examples or to slowly fade away as in the example illustrated in FIG. 2R.

FIG. 2S illustrates an example of the messaging user interface 205 in which the rendering of the animation sequence initiated in FIG. 2R continues. The animation continues to be rendered along the animation path from the animation point 260 to toward the target display location 265.

FIG. 2T illustrates an example of the messaging user interface 205 in which the animation sequence initiated in FIG. 2S continues to be rendered along the animation path that was established between the animation point 260 and the end point 265 that were determined in response to the user selecting the animation in FIG. 2M. The animation sequence follows the animation path that was established until a representation of the emoticon 290 is added to the message bubble of the message 210e at the target display location 265. The animation sequence disappears or may fade out after the sequence is completed. However, the representation of the reaction emoticon 290 remains in the message bubble of the message 210e as illustrated in FIG. 2U.

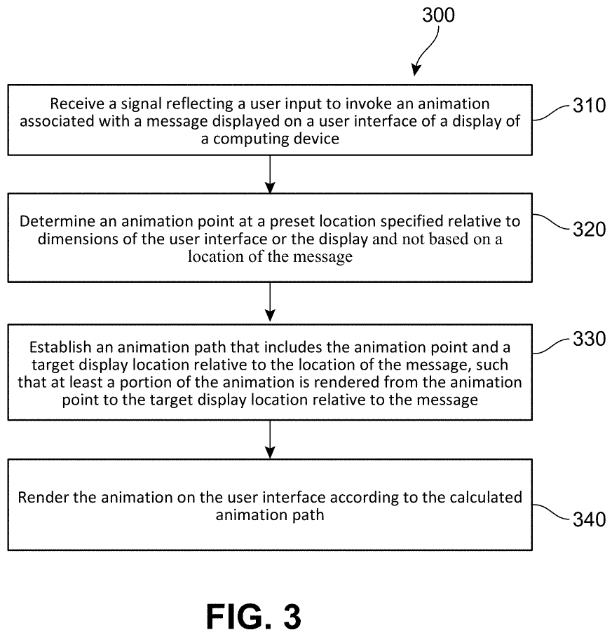

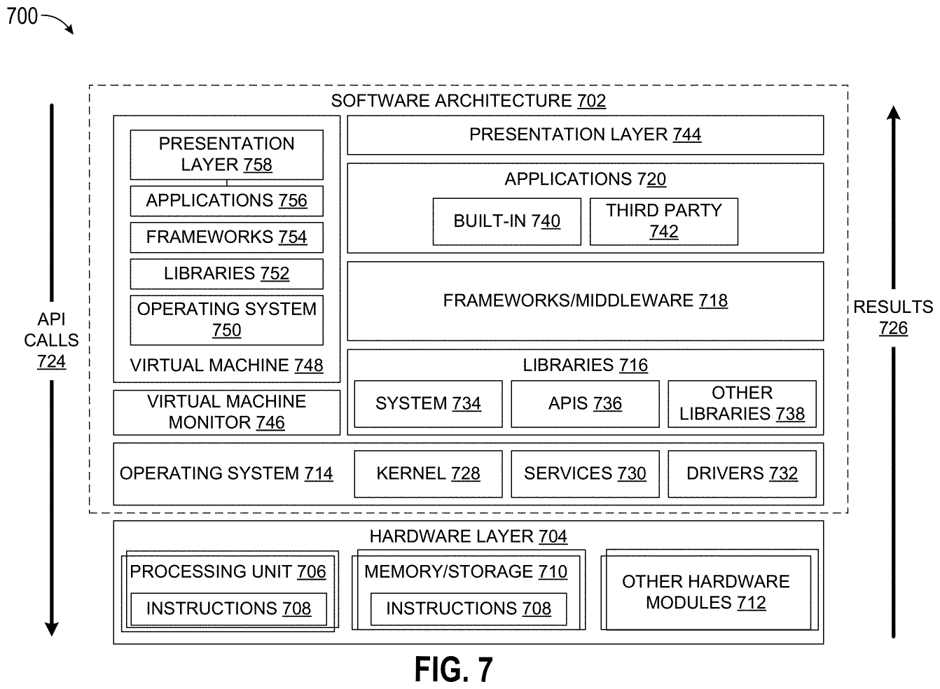

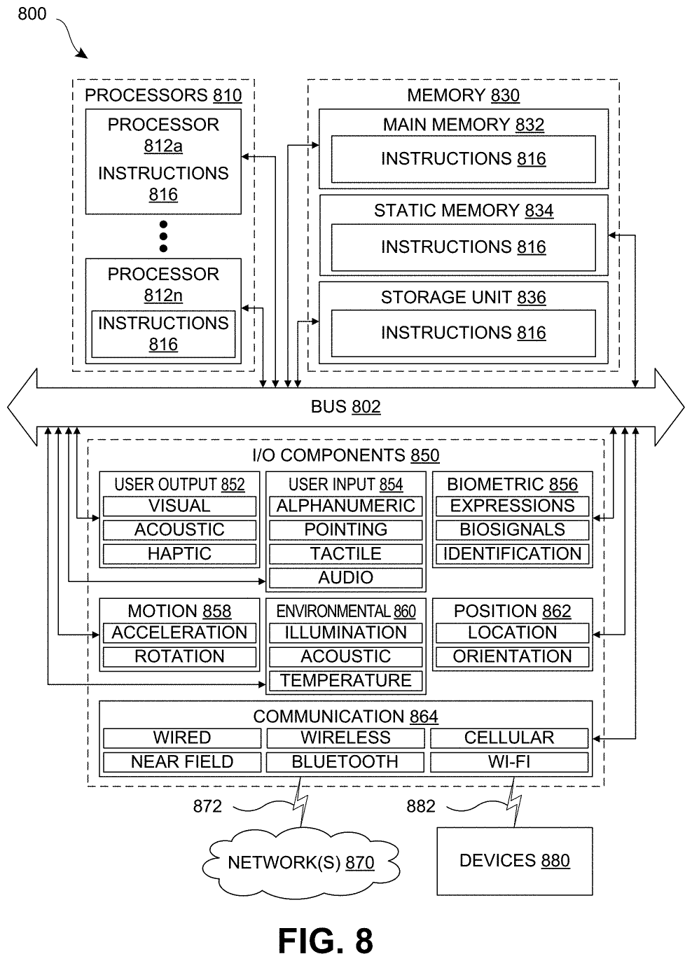

FIG. 3 is a flow chart illustrating an implementation of an example process 300 executed by a data processing system for rendering animations on a display. In some examples, some or all of the process 300 may be performed in combination with any of the features discussed in connection with FIGS. 2A-2U. The process 300 may be implemented by a data processing system, such as the user device 105 described in the proceeding examples or the example software architecture 700 illustrated in FIG. 7 and/or the example machine 800 illustrated in FIG. 8, and may be executed by a messaging application being executed on the data processing system. The data processing system may be a user device, such as the user devices 105 discussed in the preceding examples, and the user interface may be the messaging user interface 205 discussed in the preceding examples.

The process 300 may include a first operation 310 in which a signal reflecting a user input to invoke an animation associated with a message displayed on a user interface on a display of a computing device. The user may touch the message in implementations where the display of the data processing system is a touchscreen, click on the message using a pointer controlled by a touchpad or mouse, user voice commands to select the message, or any of the other various means discussed in the preceding examples.

The process 300 may also include a second operation 320 in which an animation point at a preset location specified relative to dimensions of the user interface or the display is determined and not based on a location of the message. The animation point represents an intermediate point along an animation path that is a preset location specified relative to dimensions of the user interface on which the animation is to be rendered, such as the messaging user interface 205 or the display of the device, such as the user device 105, on which the user interface is displayed. The location of the animation point may be predetermined for all animations, or a different animation point may be specified for specific animations. The location of the animation point may also be determined at least in part, based on an application in which the user interface is displayed. For example, a first messaging application may use a first animation point that is determined based on a center point of the user interface or display on which the user interface is rendered, while a second messaging application may use a second animation point that is determined from a different point relative to the user interface or display on which the user interface is rendered (e.g. top left, top center, top right, bottom left, bottom center, bottom right). Both the first and second animation points are determined relative to the dimensions of the user interface or the display but are at different locations within the user interface.

The location of the animation point may also be based at least in part on a size, shape, or both the size and shape of the animation. The animation may be centered over the animation point 300 along at least a portion of the animation path of the animation. A determination can be made as to the size and shape of the animation at the animation point. The dimensions of the frame or frames of animation to be rendered at the animation point may be determined. If these dimensions indicate that the animation would exceed the bounds of the visible area of the user interface at the animation point, the location of the animation point may be shifted horizontally or vertically on the user interface such that the animation would no longer exceed the bounds of the visible area of the user interface. Alternatively, the horizontal and vertical dimensions of the animation may be reduced to ensure that the animation remains fully visible within the user interface.

The process 300 may also include a third operation 330 in which an animation path that includes the animation point and a target display location relative to the location of the message is established. At least a portion of the animation path is rendered from the animation point to the target display location relative to the message. The target display location may be a point relative to the selected message or may be determined relative to the dimensions of the user interface or display, as discussed in the preceding examples. The animation path may render an animation that traverses the user interface in a linear path, a curvilinear path, or in a path comprising more than one linear or curvilinear segments.

The process 300 may include a fourth operation 340 in which the animation is rendered on the user interface according to the established animation path. The messaging application may access the animation indicated in the signal reflecting the user input in a memory of the user device 105. The animation may comprise a series of images or frames of animation that are to be rendered sequentially over a predetermined period. The animation may also comprise information identifying attributes of how the animation is to be rendered, such as opacity of the rendered animation, size of the rendered animation, color(s) of the rendered animation, and/or other attributes. The messaging application may render the animation along the animation path according to these attributes. The messaging application may have access to various functions of the operating system (OS), libraries, frameworks, and a presentation layer of software operating of the data processing system in order to render the user interface of the messaging application.

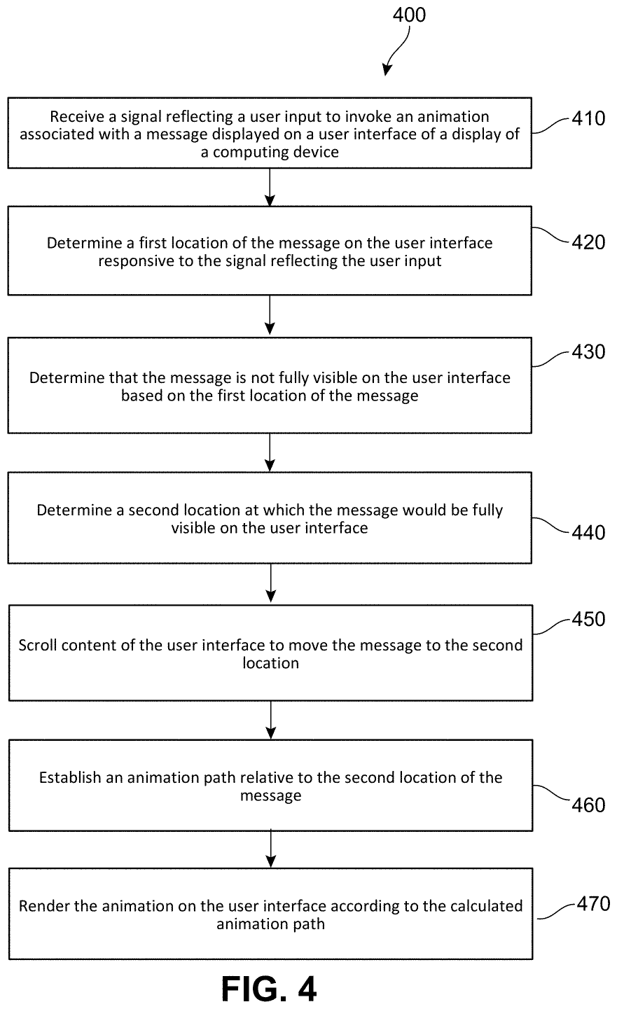

FIG. 4 is a flow chart illustrating an implementation of an example process 400 executed by a data processing system for rendering animations on a display. In some examples, some or all of the process 400 may be performed in combination with any of the features discussed in connection with FIGS. 2A-2U. The process 400 may be implemented by a data processing system, such as the user device 105 described in the proceeding examples or the example software architecture 700 illustrated in FIG. 7 and/or the example machine 800 illustrated in FIG. 8. The data processing system may be a user device, such as the user devices 105 discussed in the preceding examples, and the user interface may be the messaging user interface 205 discussed in the preceding examples.

The process 400 may include a first operation 410 in which a signal reflecting a user input to invoke an animation associated with a message displayed on a user interface on a display of a computing device. The user may touch the message in implementations where the display of the data processing system is a touchscreen, click on the message using a pointer controlled by a touchpad or mouse, user voice commands to select the message, or any of the other various means discussed in the preceding examples.

The process 400 may include a second operation 420 in which a first location of the message is determined responsive to receiving the signal. The messaging application may determine the location of the selected message using the techniques discussed in the preceding examples. The location of the message can be determined based on the message's position in the list of messages included in the messaging session being displayed by the user interface. The location of the message may also be determined based on the location of a user interface component, such as a message bubble, in which the message is rendered on the user interface of the messaging application.

The process 400 may include a third operation 430 in which a determination that the message is not fully visible on the user interface based on the location of the message on the user interface. The message associated with the user input may not be fully visible. The dimensions of the contents of the user interface may exceed the dimensions of the user interface. As messages are added by participants of the messaging session, previously entered messages may begin to scroll offscreen as the contents of the user interface exceed the dimensions of the user interface. The messaging application can determine whether the contents of the user interface have exceeded the display dimensions and can determine whether the location of the message indicates that the message falls either partly or completely outside of the visible region of the contents. The messaging application can make this determination using the techniques discussed in the preceding examples.

The process 400 may include a fourth operation 440 in which a second location is determined at which the message would be fully visible on the user interface. The messaging application can select a predetermined location on the user interface based on dimensions of the user interface. The messaging application may alternatively select from more than one predetermined location for the message in which the message would be fully visible on the user interface. The messaging application may select a predetermined location from the plurality of predetermined locations that is a shortest distance from the current position of the message to minimize the movement of the contents of the user interface when the contents are scrolled to bring the message fully into view.

The process 400 may include a fifth operation 450 in which content of the user interface is scrolled to move the message to the second location. The messaging application may have access to various functions of the operating system (OS), libraries, frameworks, and a presentation layer of software operating of the data processing system in order to render the user interface of the messaging application and may use one or more of these elements to control which portion of the contents of the messaging session are visible in the user interface. The messaging application can determine how far the contents of the need to be scrolled based on the first and second locations determined in the preceding operations.

The process 400 may include a sixth operation 460 in which an animation path is established relative to the second position of the message. The animation path may include an initial display location, an animation point, and a target display location as discussed in the preceding examples. The target display location may be determined based on the second location of the message. An emoticon or other graphical representation of the reaction animation may be added to the message. The location where the emoticon or other graphical representation is rendered depends on the configuration of the message bubble or other graphical representation which is used to represent the message in the user interface. The messaging application may determine the location of a reaction icon placement area 230, and an offset within the reaction icon placement area 230 based on how many reactions have already been added to the message.

The process 400 may include a seventh operation 470 in which the animation is rendered on the user interface according to the established animation path. The messaging application may render the animation on the user interface according to the established animation path as discussed in the preceding examples.

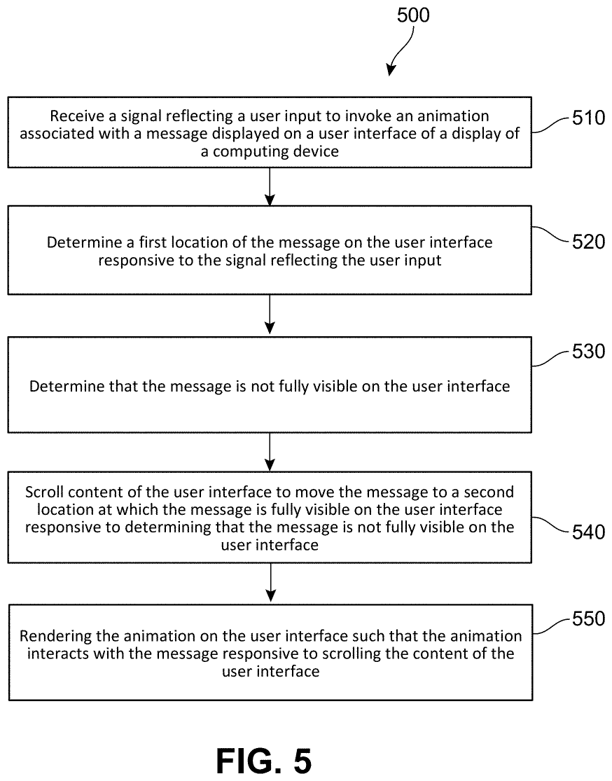

FIG. 5 is a flow chart illustrating an implementation of an example process 500 executed by a data processing system for rendering animations on a display. In some examples, some or all of the process 500 may be performed in combination with any of the features discussed in connection with FIGS. 2A-2U. The process 500 may be implemented by a data processing system, such as the user device 105 described in the proceeding examples or the example software architecture 700 illustrated in FIG. 7 and/or the example machine 800 illustrated in FIG. 8. The data processing system may be a user device, such as the user devices 105 discussed in the preceding examples, and the user interface may be the messaging user interface 205 discussed in the preceding examples.

The process 500 may include a first operation 510 in which a signal reflecting a user input to invoke an animation associated with a message displayed on a user interface on a display of a computing device. The user may touch the message in implementations where the display of the data processing system is a touchscreen, click on the message using a pointer controlled by a touchpad or mouse, user voice commands to select the message, or any of the other various means discussed in the preceding examples.

The process 500 may include a second operation 520 in which a first location of the message on the user interface is determined responsive to receiving the signal. The messaging application may determine the location of the selected message using the techniques discussed in the preceding examples. The location of the message can be determined based on the message's position in the list of messages included in the messaging session being displayed by the user interface. The location of the message may also be determined based on the location of a user interface component, such as a message bubble, in which the message is rendered on the user interface of the messaging application.

The process 500 may include a third operation 530 in which a determination can be made that the message is not fully visible on the user interface 530. The messaging application can determine whether the contents of the user interface have exceeded the display dimensions and make a determination whether the location of the message indicates that the message falls either partly or completely outside of the visible region of the contents. The messaging application can make this determination using the techniques discussed in the preceding examples.

The process 500 may include a fourth operation 540 in which the contents of the user interface can be scrolled to move the message to a second location in which the message is fully visible on the user interface responsive to determining that the message is not fully visible. The contents of the user interface may be scrolled such that the message is moved to a predetermined location on the screen. The predetermined location may coincide with initial display location, an animation point, or a target display location associated with the animation path along which the animation will be rendered. The messaging application can cause the contents of the messaging user interface 205 to scroll as discussed in the preceding examples to cause the portion of the content visible in the messaging user interface 205 to change.

The process 500 may include a fifth operation 550 in which the animation is rendered on the user interface such that the animation interacts with the message responsive to scrolling the contents of the user interface. For example, at least a portion of the animation may be rendered on or proximate to a representation of the message in the user interface, and an emoticon or other graphical representation of the reaction animation may be added to the message as discussed in the preceding examples.

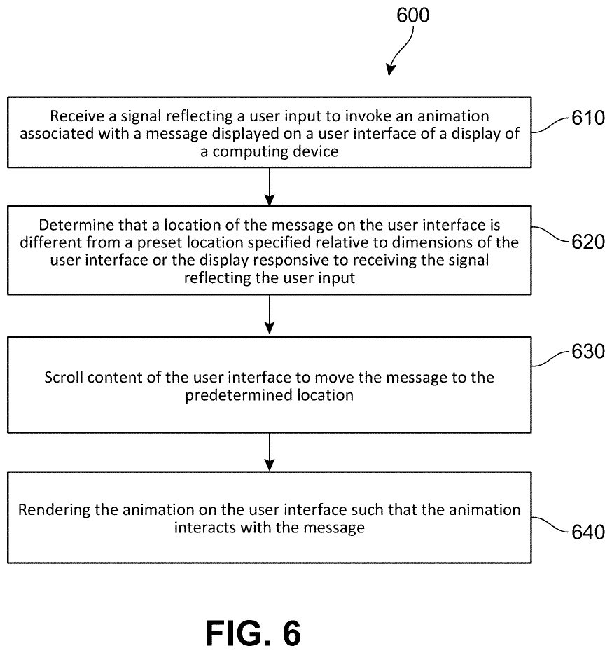

FIG. 6 is a flow chart illustrating an implementation of an example process 600 executed by a data processing system for rendering animations on a display. In some examples, some or all of the process 600 may be performed in combination with any of the features discussed in connection with FIGS. 2A-2U. The process 600 may be implemented by a data processing system, such as the user device 105 described in the proceeding examples or the example software architecture 700 illustrated in FIG. 7 and/or the example machine 800 illustrated in FIG. 8. The data processing system may be a user device, such as the user devices 105 discussed in the preceding examples, and the user interface may be the messaging user interface 205 discussed in the preceding examples.

The process 600 may include a first operation 610 in which a signal reflecting a user input to invoke an animation associated with a message displayed on a user interface on a display of a computing device. The user may touch the message in implementations where the display of the data processing system is a touchscreen, click on the message using a pointer controlled by a touchpad or mouse, user voice commands to select the message, or any of the other various means discussed in the preceding examples.

The process 600 may include a second operation 620 in which a determination is made that a location of the message on the user interface is different from a preset location specified relative to dimensions of the user interface or the display responsive to receiving the signal. The messaging application can determine the current location of the message within the user interface using the techniques discussed in the preceding examples. The messaging application can compare the current location of the message with the predetermined location to determine if the two locations are different. This approach may be used by the messaging application where the animations to be rendered have an animation path that may be at least partly preset. For example, one or more of the initial display location, the animation point, or the target display location may be preset points, and the message may be positioned at the preset location so that the message aligns with the preset animation path.

The process 600 may third a third operation 630 in which the contents of the user interface are scrolled to move the message to the predetermined location in which the message is fully visible on the user interface responsive to determining that the message is not fully visible. The messaging application can scroll the contents of the user interface of the messaging application as discussed in the preceding examples.

The process 600 may include a fourth operation 640 in which the animation is rendered on the user interface such that the animation interacts with the message. For example, at least a portion of the animation may be rendered on or proximate to a representation of the message in the user interface, and an emoticon or other graphical representation of the reaction animation may be added to the message as discussed in the preceding examples.

Examples of the operations illustrated in the flow charts shown in FIGS. 3-6 are described in connection with FIGS. 1-2U. It is understood that the specific orders or hierarchies of elements and/or operations disclosed in FIGS. 3-6 are example approaches. Based upon design preferences, it is understood that the specific orders or hierarchies of elements and/or operations in FIGS. 3-6 can be rearranged while remaining within the scope of the present disclosure. FIGS. 3-6 present elements of the various operations in sample orders and are not meant to be limited to the specific orders or hierarchies presented. Also, the accompanying claims present various elements and/or various elements of operations in sample orders and are not meant to be limited to the specific elements, orders, or hierarchies presented.

The detailed examples of systems, devices, and techniques described in connection with FIGS. 1-6 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-6 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

FIG. 7 is a block diagram 700 illustrating an example software architecture 702, various portions of which may be used in conjunction with various hardware architectures herein described, which may implement any of the above-described features. FIG. 7 is a non-limiting example of a software architecture and it will be appreciated that many other architectures may be implemented to facilitate the functionality described herein. The software architecture 702 may execute on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 includes a processing unit 706 and associated executable instructions 708. The executable instructions 708 represent executable instructions of the software architecture 702, including implementation of the methods, modules and so forth described herein. The hardware layer 704 also includes a memory/storage 710, which also includes the executable instructions 708 and accompanying data. The hardware layer 704 may also include other hardware modules 712. Instructions 708 held by processing unit 708 may be portions of instructions 708 held by the memory/storage 710.

The example software architecture 702 may be conceptualized as layers, each providing various functionality. For example, the software architecture 702 may include layers and components such as an operating system (OS) 714, libraries 716, frameworks 718, applications 720, and a presentation layer 744. Operationally, the applications 720 and/or other components within the layers may invoke API calls 724 to other layers and receive corresponding results 726. The layers illustrated are representative in nature and other software architectures may include additional or different layers. For example, some mobile or special purpose operating systems may not provide the frameworks/middleware 718.

The OS 714 may manage hardware resources and provide common services. The OS 714 may include, for example, a kernel 728, services 730, and drivers 732. The kernel 728 may act as an abstraction layer between the hardware layer 704 and other software layers. For example, the kernel 728 may be responsible for memory management, processor management (for example, scheduling), component management, networking, security settings, and so on. The services 730 may provide other common services for the other software layers. The drivers 732 may be responsible for controlling or interfacing with the underlying hardware layer 704. For instance, the drivers 732 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 716 may provide a common infrastructure that may be used by the applications 720 and/or other components and/or layers. The libraries 716 typically provide functionality for use by other software modules to perform tasks, rather than rather than interacting directly with the OS 714. The libraries 716 may include system libraries 734 (for example, C standard library) that may provide functions such as memory allocation, string manipulation, file operations. In addition, the libraries 716 may include API libraries 736 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 716 may also include a wide variety of other libraries 738 to provide many functions for applications 720 and other software modules.

The frameworks 718 (also sometimes referred to as middleware) provide a higher-level common infrastructure that may be used by the applications 720 and/or other software modules. For example, the frameworks 718 may provide various graphic user interface (GUI) functions, high-level resource management, or high-level location services. The frameworks 718 may provide a broad spectrum of other APIs for applications 720 and/or other software modules.

The applications 720 include built-in applications 740 and/or third-party applications 742. Examples of built-in applications 740 may include, but are not limited to, a contacts application, a browser application, a location application, a media application, a messaging application, and/or a game application. Third-party applications 742 may include any applications developed by an entity other than the vendor of the particular platform. The applications 720 may use functions available via OS 714, libraries 716, frameworks 718, and presentation layer 744 to create user interfaces to interact with users.

Some software architectures use virtual machines, as illustrated by a virtual machine 748. The virtual machine 748 provides an execution environment where applications/modules can execute as if they were executing on a hardware machine (such as the machine 800 of FIG. 8, for example). The virtual machine 748 may be hosted by a host OS (for example, OS 714) or hypervisor, and may have a virtual machine monitor 746 which manages operation of the virtual machine 748 and interoperation with the host operating system. A software architecture, which may be different from software architecture 702 outside of the virtual machine, executes within the virtual machine 748 such as an OS 714, libraries 752, frameworks 754, applications 756, and/or a presentation layer 758.

FIG. 8 is a block diagram illustrating components of an example machine 800 configured to read instructions from a machine-readable medium (for example, a machine-readable storage medium) and perform any of the features described herein. The example machine 800 is in a form of a computer system, within which instructions 816 (for example, in the form of software components) for causing the machine 800 to perform any of the features described herein may be executed. As such, the instructions 816 may be used to implement modules or components described herein. The instructions 816 cause unprogrammed and/or unconfigured machine 800 to operate as a particular machine configured to carry out the described features. The machine 800 may be configured to operate as a standalone device or may be coupled (for example, networked) to other machines. In a networked deployment, the machine 800 may operate in the capacity of a server machine or a client machine in a server-client network environment, or as a node in a peer-to-peer or distributed network environment. Machine 800 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 800 is illustrated, the term “machine” includes a collection of machines that individually or jointly execute the instructions 816.

The machine 800 may include processors 810, memory 830, and I/O components 850, which may be communicatively coupled via, for example, a bus 802. The bus 802 may include multiple buses coupling various elements of machine 800 via various bus technologies and protocols. In an example, the processors 810 (including, for example, a central processing unit (CPU), a graphics processing unit (GPU), a digital signal processor (DSP), an ASIC, or a suitable combination thereof) may include one or more processors 812a to 812n that may execute the instructions 816 and process data. In some examples, one or more processors 810 may execute instructions provided or identified by one or more other processors 810. The term “processor” includes a multi-core processor including cores that may execute instructions contemporaneously. Although FIG. 8 shows multiple processors, the machine 800 may include a single processor with a single core, a single processor with multiple cores (for example, a multi-core processor), multiple processors each with a single core, multiple processors each with multiple cores, or any combination thereof. In some examples, the machine 800 may include multiple processors distributed among multiple machines.

The memory/storage 830 may include a main memory 832, a static memory 834, or other memory, and a storage unit 836, both accessible to the processors 810 such as via the bus 802. The storage unit 836 and memory 832, 834 store instructions 816 embodying any one or more of the functions described herein. The memory/storage 830 may also store temporary, intermediate, and/or long-term data for processors 810. The instructions 816 may also reside, completely or partially, within the memory 832, 834, within the storage unit 836, within at least one of the processors 810 (for example, within a command buffer or cache memory), within memory at least one of I/O components 850, or any suitable combination thereof, during execution thereof. Accordingly, the memory 832, 834, the storage unit 836, memory in processors 810, and memory in I/O components 850 are examples of machine-readable media.

As used herein, “machine-readable medium” refers to a device able to temporarily or permanently store instructions and data that cause machine 800 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 816) for execution by a machine 800 such that the instructions, when executed by one or more processors 810 of the machine 800, cause the machine 800 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 850 may include a wide variety of hardware components adapted to receive input, provide output, produce output, transmit information, exchange information, capture measurements, and so on. The specific I/O components 850 included in a particular machine will depend on the type and/or function of the machine. For example, mobile devices such as mobile phones may include a touch input device, whereas a headless server or IoT device may not include such a touch input device. The particular examples of I/O components illustrated in FIG. 8 are in no way limiting, and other types of components may be included in machine 800. The grouping of I/O components 850 are merely for simplifying this discussion, and the grouping is in no way limiting. In various examples, the I/O components 850 may include user output components 852 and user input components 854. User output components 852 may include, for example, display components for displaying information (for example, a liquid crystal display (LCD) or a projector), acoustic components (for example, speakers), haptic components (for example, a vibratory motor or force-feedback device), and/or other signal generators. User input components 854 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 850 may include biometric components 856, motion components 858, environmental components 860, and/or position components 862, among a wide array of other physical sensor components. The biometric components 856 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 858 may include, for example, acceleration sensors (for example, an accelerometer) and rotation sensors (for example, a gyroscope). The environmental components 860 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 862 may include, for example, location sensors (for example, a Global Position System (GPS) receiver), altitude sensors (for example, an air pressure sensor from which altitude may be derived), and/or orientation sensors (for example, magnetometers).

The I/O components 850 may include communication components 864, implementing a wide variety of technologies operable to couple the machine 800 to network(s) 870 and/or device(s) 880 via respective communicative couplings 872 and 882. The communication components 864 may include one or more network interface components or other suitable devices to interface with the network(s) 870. The communication components 864 may include, for example, components adapted to provide wired communication, wireless communication, cellular communication, Near Field Communication (NFC), Bluetooth communication, Wi-Fi, and/or communication via other modalities. The device(s) 880 may include other machines or various peripheral devices (for example, coupled via USB).

In some examples, the communication components 864 may detect identifiers or include components adapted to detect identifiers. For example, the communication components 864 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 862, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A computing device comprising:
a display configured to display a user interface;
a processor; and
a computer-readable medium storing instructions that, when executed by the processor, cause the processor to control the computing device to perform functions of:
receiving a first user input to invoke an animation associated with a message displayed via the user interface;
determining, based on a first dimension of the display or a second dimension of the user interface, a preset location for an animation point on the user interface, wherein the preset location is relative to the first dimension of the display or the second dimension of the user interface, the preset location being determined independently from a location of the message on the user interface;
establishing an animation path that includes the preset location for the animation point and a target display location determined based on the location of the message, such that at least a portion of the animation is rendered from the preset location for the animation point to the target display location; and
rendering the animation on the user interface according to the established animation path.

2. The computing device of claim 1, wherein the instructions, when executed by the processor, further cause the processor to control the computing device to perform a function of moving content displayed via the user interface such that the message associated with the animation is fully visible via the user interface prior to establishing the animation path.

3. The computing device of claim 1, wherein the instructions, when executed by the processor, further cause the processor to control the computing device to perform functions of:
receiving a second user input to select the message displayed via the user interface; and
in response to receiving the second user input, displaying an animation selection interface, wherein the first user input is received via the animation selection interface.

4. (canceled)

5. (canceled)

6. The computing device of claim 1, wherein the target display location falls within a portion of the user interface corresponding to the message.

7. The computing device of claim 1, wherein the instructions, when executed by the processor, further cause the processor to control the computing device to perform a function of monitoring a change to the location of the message on the user interface.

8. The computing device of claim 7, wherein the instructions, when executed by the processor, further cause the processor to control the computing device to perform a function of reestablishing the animation path in response to the change to the location of the message.

9-20. (canceled)

21. The computing device of claim 1, wherein the second dimension of the user interface comprises:
a first length along a first axis of a viewable area of the user interface; and
a second length along a second axis of the viewable area of the user interface, the second axis being perpendicular to the first axis.

22. The computing device of claim 1, wherein the preset location is a center point of a viewable area of the user interface.

23. The computing device of claim 1, wherein the preset location is offset from a center point of a viewable area of the user interface.

24. The computing device of claim 1, wherein the animation rendered at the preset location does not exceed a boundary of the viewable area of the user interface.

25. A method of operating a computing device for rendering an animation via a user interface of a display, comprising:
receiving a first signal reflecting a first user input to invoke an animation associated with a message displayed via the user interface;
determining, based on a first dimension of the display or a second dimension of the user interface, a preset location for an animation point on the user interface, wherein the preset location is relative to the first dimension of the display or the second dimension of the user interface, the preset location being determined independently from a location of the message on the user interface;
establishing an animation path that includes the animation point location and a target display location determined based on the location of the message, such that at least a portion of the animation is rendered from the animation point location to the target display location; and
rendering the animation on the user interface according to the established animation path.

26. The method of claim 25, further comprising moving content displayed via the user interface such that the message associated with the animation is fully visible via the user interface prior to establishing the animation path.

27. The method of claim 25, further comprising:
receiving a second user input to select the message displayed via the user interface; and
in response to receiving the second signal, displaying an animation selection interface, wherein the first user input is received via the animation selection interface.

28. The method of claim 25, wherein the target display location falls within a portion of the user interface corresponding to the message.

29. The method of claim 25, further comprising:
monitoring a change to the location of the message on the user interface; and
reestablishing the animation path in response to the change to the location of the message.

30. The method of claim 25, wherein the second dimension of the user interface comprises:
a first length along a first axis of a viewable area of the user interface; and
a second length along a second axis of the viewable area of the user interface, the second axis being perpendicular to the first axis.

31. The method of claim 25, wherein the preset location is a center point of a viewable area of the user interface.

32. The method of claim 25, wherein the preset location is offset from a center point of a viewable area of the user interface.

33. A non-transitory computer readable medium containing instructions which, when executed by a processor, cause a computing device to perform functions for rendering an animation via a user interface of a display, the functions comprising:
receiving a first signal reflecting a first user input to invoke an animation associated with a message displayed via the user interface;
determining, based on a first dimension of the display or a second dimension of the user interface, a preset location for an animation point on the user interface, wherein the preset location is relative to the first dimension of the display or the second dimension of the user interface, the preset location being determined independently from a location of the message on the user interface;
establishing an animation path that includes the animation point location and a target display location determined based on the location of the message, such that at least a portion of the animation is rendered from the animation point location to the target display location; and
rendering the animation on the user interface according to the established animation path.

34. The non-transitory computer readable medium of claim 42, wherein the second dimension of the user interface comprises:
a first length along a first axis of a viewable area of the user interface; and
a second length along a second axis of the viewable area of the user interface, the second axis being perpendicular to the first axis.
